(19) United States
(12) Patent Application Publication
(10) Pub. No.: US 2022/0001317 A1
(43) Pub. Date: Jan. 6, 2022

(54) NANO SILVER ACTIVE FILTER ELEMENT AND A METHOD FOR PREPARING THE NANO SILVER ACTIVE FILTER

(71) Applicant: Donogguan AIR Guard Manufacturing Co., Ltd., Dongguan (CN)

(72) Inventor: Jipeng ZHAO, Donguan (CN)

(21) Appl. No.: 17/478,944

(22) Filed: Sep. 19, 2021

(30) Foreign Application Priority Data
Sep. 19, 2020 (CN) 202010989739.5

(51) Int. Cl. B01D 46/00; B01D 39/16; B01D 46/52

(52) U.S. Cl. CPC B01D 46/0028; B01D 39/16; B01D 46/0001; B01D 46/522; B01D 2279/65; B01D 2239/065; B01D 2239/0681; B01D 2275/10; B01D 2239/0442

(57) ABSTRACT

A nano silver active filter element comprises a filter element body which comprises sheet filter papers stacked of layered composite structures, the sheet filter papers successively comprises a nano silver antibacterial layer, a filter layer and a protection layer from an air inlet surface to an air outlet surface; the nano silver antimicrobial layer is prepared from phenolic complex fibers loaded with nano silver particles.

### FIELD OF THE INVENTION

The invention relates to air purification technical field, more particularly relates to nano silver active filter element and the method for preparing the nano silver active filter.

### BACKGROUND OF THE INVENTION

As the continuous advancement of China's industrialization process, the environmental pollution problem is becoming increasingly prominent, especially the air pollution problem has seriously affected people's life and health. The environmental problems make people's awareness of air pollution protection strengthened and air purifiers are increasingly widely used. However, the air purifiers plays a certain role in filtering the air, it can not inhibit the growth and reproduction of harmful bacteria on the filter element after the process of filtering the air, and it can not effectively protect personal health.

At present, most of the schemes to inhibit the breeding of the harmful bacteria on the filter element are achieved by spraying antimicrobial agents on the surface of the filter element. The antimicrobial agents can be divided into organic antimicrobial agents, natural antimicrobial agents and inorganic antimicrobial agents. The antimicrobial agents are banned due to poor safety and serious environmental pollution; the natural antimicrobial agents are less used because of poor heat resistance and durability, while the inorganic antimicrobial agents are widely used in many industries because they have the characteristics of high durability, good heat resistance, low drug resistance and high safety. The inorganic antimicrobial agents studied most are silver antibiotics, Most of the inorganic antimicrobial agents which are commercialized are silver antibiotics; including silver ions, metal silver and nano particles. The silver antibiotics include silver ions, metal silver and nano particles.

Compared with the silver ions, the metal silver, the nano particles are widely used because of the quantum effects of the nano particles, the small size effects and the great specific surface area, However, although the antimicrobial agents is sprayed on the surface of the filter element, the antimicrobial agent is not firmly attached and easy to fall off from the the surface of the filter element, the antibacterial performance is poor, and the nano particles falling off from the surface of the filter element is easily adsorbed by person and damage personal health. The filter element attached the antimicrobial agent can not be washed by water, which has poor water resistance, thereby it can not achieve the effect of long-term antibacterial, good antibacterial performance.

### SUMMARY OF THE INVENTION

The object of the present invention is to provided a kind of nano silver active filter element to solve the technical problems that the antibacterial agent unfirmly attached and easy to fall off from the filter element, the nano particles falling off from the surface of the filter element is easily adsorbed by person and damage personal health, and the filter element attached by the antimicrobial agent is not washable, which has poor water resistance.

In order to achieve the above object, the present invention provides a kind of nano silver active filter element, which includes a filter element body comprising sheet filter papers stacked of layered composite structures, the sheet filter papers successively comprises a nano silver antibacterial layer, a filter layer and a protection layer from an air inlet surface to an air outlet surface. The nano silver antimicrobial layer is prepared from phenolic complex fibers loaded with nano silver particles. The nano silver antimicrobial layer enables nano silver particles binding phenolic compound with diversity structures so as to more tightly combined with the carrier and difficult to fall off from the carrier, thereby increasing the antibacterial performance, and it can be washed.

Optionally, the sheet filter papers is arranged in a W-shaped structure, which increases the adsorption and filtration efficiency of a unit area.

Optionally, the layers of the sheet filter papers are integrated in a whole by ultrasonic thermal pressure.

Optionally, the fixed surface and/or a bottom surface of the sheet filter papers are glued to form a glue line is in W shape.

Optionally, the nano silver active filter element also includes a frame, which is arranged at a side surface of the sheet filter papers. The sheet filter papers are seamlessly bonded to the frame in a hot melt manner. The structure is designed to strengthen the strength of the sheet filter papers and facilitate the disinfection and purification the filter element.

Optionally, a side of the frame departing from the sheet filter papers is provided with a sealing member. The structure is designed to enhance the air tightness of the filter element.

The one or more of the above technical schemes of the nano silver active filter element provided in embodiments of the present invention have at least one of the following technical effects:

The nano silver antimicrobial layer is arranged on the inlet surface of the nano silver active filter element, the polyester nonwoven cloth is impregnated in a phenolic compound solution to obtain a phenolic composite fiber cloth attached with the phenolic compound. After a loading reaction of the phenolic composite fiber cloth and the suspension containing nano silver ion, it is dried so that the nano silver ion is loaded on the micropore structure of the phenolic composite fiber cloth. The present invention uses the structural diversity of phenolic compound to change the nano silver ion into different shapes, make it more tightly combined with phenolic composite fiber cloth, not easy to fall off from it and enhance the antibacterial performance, and it can be washed with water to achieve the effect of long-term antibacterial and antibacterial performance, with potential market economic value and strong promotion function.

The filter layer uses HEPA layer to effectively filter small particulate matter such as automobile exhaust gas, PM2.5 and heavy metal, the filtration effect reaches more than 97%, which can further strengthen the filter efficiency of the filter element. In addition, the protective layer is made of water-resistant fiber material to ensure waterproof entry and good air permeability, long service life, and further strengthen the antimicrobial properties of the nano silver antibacterial layer.

The second objection of the present invention is to provide a method for preparing the nano silver active filter element, comprising the following steps:

S1:preparation of phenolic composite fiber;

S2: preparation of a suspension containing nano silver ion;

S3: preparation of the nano silver antimicrobial layer by loading the nano silver ion in the suspension obtained in step S2 into the surface microporous structure of the phenolic composite fiber obtained in step S1;

S4: the nano silver antimicrobial layer, the filter layer, and the protective layer are stacked sequentially, which is processed into a coiled material by ultrasonic processing, the coiled material is cut into required specification through the strip machine; then the coiled material with the required specification is folded into W-shaped structure by a non-woven folding machine;

S5: according to the specific shape structure of the filter element, select the shaping mold and cutting mold that meet the requirements to cut the W-shaped structure obtained in step S3 to obtain the block sheet filter paper with required size; the fixed surface and/or the bottom surface of the block sheet filter paper is glued to obtain a block sheet filter paper with predetermined fold angle parameters and finalized; the frame is adhesive to the periphery of the block sheet filter paper by hot melt to obtain the filter element body.

Optionally, in step S1, the specific preparation procedure is as follows:

S11: a polyester non-woven cloth is dried at 100° C.˜200° C. for 1 h˜5 h, then pick it out and steam it in boiling water;

S12: add 120 g˜180 g trihydromethylaminomethane into 800 ml of deionized water in 1 L beaker, fully stir to dissolve the trihydromethylaminomethane, cool to room temperature, add 20 ml˜70 ml thick HCl into the beaker, dilute the solution to 1L, after high temperature and high pressure sterilization; store it at room temperature, obtain trihydroxymethyl aminomethane-hydrochloride (TRIS-HCL) buffer with pH 7.4˜8.8;

S13: dissolve 4 g˜15 g of phenolic compound in the trihydroxymethyl aminomethane-hydrochloride buffer obtained in step S12 to obtain a phenolic compound solution with a concentration of 0.5 g/L˜4 g/L;

S14: the polyester fiber non-woven cloth obtained in step S11 is immersed in the phenolic compound solution obtained in step S13 at a bath ratio of 1:50, and the reaction is stirred for 10 min˜30 min at room temperature at a stirring speed of 100 r/min˜200 r/min.

S15: Take out the polyester fiber non-woven cloth treated in step S14, wash it with deionized water and absolute ethanol for 2˜5 times in turn, and air dry to obtain the phenolic composite fiber cloth with phenolic compound.

Optionally, in step S2, the specific preparation process is as follows:

S21: the nano silver wire, silicone and ethylene glycol are mixed at 100° C.˜120° C. according to the mass fraction ratio (0.01˜0.04): (1˜4): 1, and stirred for 2 h˜4 h at a stirring speed of 150 r/min˜300 r/min; the fully reacted solution is washed and dried to obtain modified silver nanowires;

S22: the modified nano silver wire obtained in step S21 is added to the mixed liquid that mass ratio is 1: (3˜5): (2˜4) a mixture of water, ethylene glycol and isopropanol to obtain a suspension containing nano silver ions with a mass ratio of 0.01%˜0.1%.

Optionally, in step S3, the specific preparation process is as follows:

S31: the phenolic composite fiber cloth obtained in step S15 and the suspension containing nano silver ions obtained in step S22 are performed loading reaction by stirring and ultrasonically vibrating at a mass fraction ratio of 1:50˜1:150 under the conditions of reaction temperature of 60° C.˜90° C. and reaction time of 30 min˜50 min;

S32: after the loading reaction in step S31, the nano silver antibacterial layer is obtained by drying at a drying temperature of 30° C.˜50° C. and a drying time of 3 h˜8 h.

One or more of the above technical schemes for the preparation of nanosilver active filter elements provided in embodiments of the present invention have at least one of the following technical effects:

The preparation method of the present invention obtains a polyester fiber non-woven cloth attached with phenolic compound by immersing the phenolic composite fiber cloth in a phenolic compound solution; after the phenolic composite fiber cloth and the suspension liquid containing the nano silver ions are performed loading reaction, it is dried to obtain the nanosilver antibacterial layer, the nanosilver ions are fixed in the surface micropore structure of phenolic composite fiber cloth. The present invention uses phenolic composite fiber cloth with phenolic compound, make nano silver ions into different shapes, through various bond cooperation, strengthen the adhesion of nano silver ions, realize nano silver ions firmly fixed in phenolic composite fiber fabric surface microporous structure, not easy to fall off, and antibacterial effect is significant, and can be washed, effectively solve the antibacterial performance, antibacterial performance, another detached nano particles adsorption damage personal health. And the waterwashing of the filter element attached to antibacterial agent causes poor water resistance, realize the effect of long-term effect antibacterial and strong antibacterial performance, and further strengthen the antibacterial filtration effect of the nano silver active filter element.

### BRIEF DESCRIPTION OF THE DRAWINGS

To more clearly illustrate the technical scheme in the embodiments of the invention, the embodiment or drawings drawings in the prior art description, the following drawings are merely some embodiments of the invention, and for those skilled in the art, additional drawings may be obtained without paying creative labour.

FIG. 1 is a structural diagram of the nano silver active filter element according to an embodiment of the present invention.

FIG. 2 is a decomposition structure diagram of the nano silver active filter element according to an embodiment of the present invention.

FIG. 3 is a structural diagram of the outer frame adhesive seal member according to an embodiment of the present invention.

FIG. 4 is a explode view of a sheet filter paper according to an embodiment of the present invention;

FIG. 5 shows a partially enlarged schematic diagram of A indicated in FIG. 2;

FIG. 6 is a flow chart of the preparation method of the nano silver active filter element according to the invention.

### EMBODIMENTS

The followings will further descript the present invention with the embodiments, which are the preferable embodiments in the present invention.

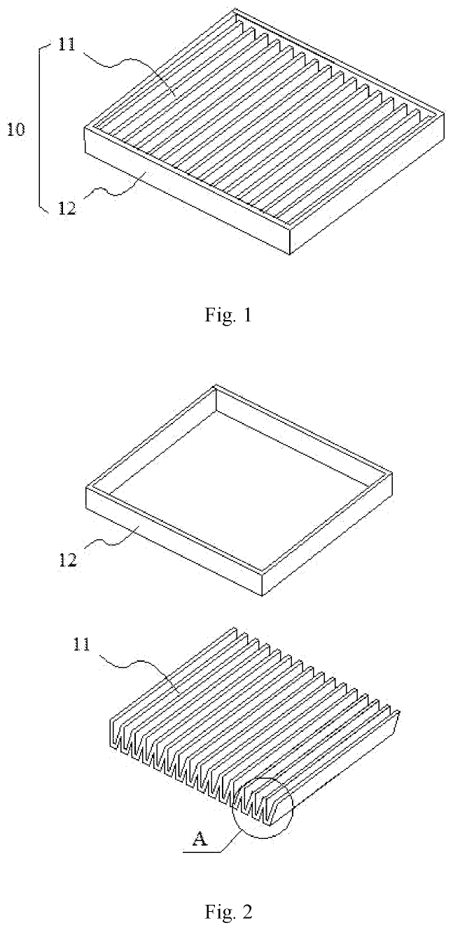

In one embodiment of the present invention, as shown in FIG. 1˜2, the present invention provides a kind of nano silver active filter element, which includes a filter element body 10 comprising sheet filter papers 12 stacked of layered composite structures and a frame 12. Specifically, the frame 12 is arranged at a side surface of the sheet filter papers 11. The sheet filter papers 11 are seamlessly bonded to the frame 12 in a hot melt manner. The frame 12 enhances the stability of the nano silver active filter element, greatly strengthens the support hardness, not easy to deformation and strong. In specific practice, the nano silver active filter element can be used on the car air conditioning, but also used on the home purifier or other air filtration equipment. The nano silver active filter element can be designed in a block, cylindrical or triangular shape to fit the air filtration equipment.

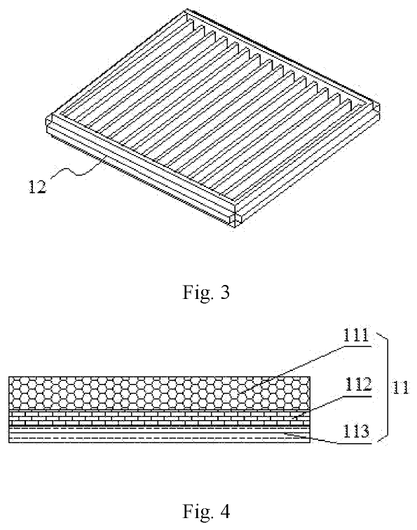

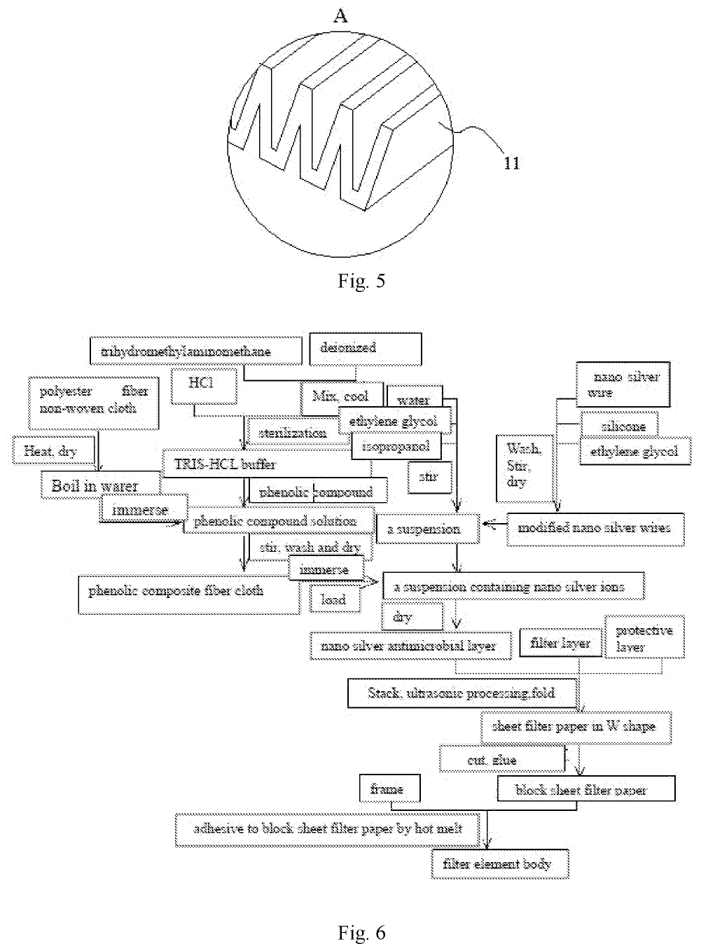

As shown in FIG. 3, the frame 12 is provided with a sealing member 121 on the side of the frame departing from the sheet filter papers 11. The structure is designed to enhance the air tightness of the filter element. Specifically, the sealing member 121 may be made of sponge or rubber to seal the frame 12 to prevent air leakage from the frame in order to improve the filtering efficiency and accuracy of the nano silver active filter element 11.

As shown in FIG. 4, the sheet filter papers 11 successively comprises a nano silver antibacterial layer 111, a filter layer 112 and a protection layer 113 from an air inlet surface to an air outlet surface. The nano silver antimicrobial layer 111 is prepared from phenolic complex fibers fixed with nano silver particles. The layers of the sheet filter papers 11 are integrated a whole by ultrasonic thermal pressure, or adhered a whole by hot melt. The nano silver antibacterial layer 111 is obtained by immersing the polyester fiber non-woven cloth in a phenolic compound solution to obtain the phenolic composite fiber cloth attached with phenolic compound; after the phenolic composite fiber cloth and the suspension liquid containing the nano silver ions are performed loading reaction, it is dried so that the nanosilver ions are fixed in the surface micropore structure of phenolic composite fiber cloth. The present invention uses the structural diversity of phenolic compound to change the nano silver ion into different shapes, make it more tightly combined with phenolic composite fiber cloth, not easy to fall off from it and enhance the antibacterial performance, and it can be washed with water to achieve the effect of long-term antibacterial and antibacterial performance.

Further, the filter layer uses HEPA layer to effectively filter small particulate matter such as automobile exhaust gas, PM2.5 and heavy metal, the filtration effect reaches more than 97%, which can further strengthen the filter efficiency of the filter element. In addition, the protective layer is made of water-resistant fiber material to ensure waterproof entry and good air permeability, long service life, and further strengthen the antimicrobial properties of the nano silver antibacterial layer 111.

As shown in FIG. 4, the sheet filter papers 11 is arranged in a W-shaped structure. The structure design greatly increases the contact area with the air, can better filter the harmful substances in the air, and plays a more effective antibacterial effect, increasing the adsorption and filtration efficiency per unit area. Further, in order to make the sheet layer 11 better fixed after folding without extending along the shape before resuming its folding, and to produce the specific technical parameters of the purification filter element, the adhesive formed after adhesive is a W setting by adhesive and/or the bottom surface of the sheet paper 11.

The second objection of the present invention is to provide a method for preparing the nano silver active filter element. As shown in FIG. 6, by immersing the polyester fiber non-woven cloth in a phenolic compound solution to obtain the phenolic composite fiber cloth attached with phenolic compound; after the phenolic composite fiber cloth and the suspension liquid containing the nano silver ion are performed loading reaction, it is dried so that the nano silver ions are fixed in the surface micropore structure of phenolic composite fiber cloth. The present invention uses the structural diversity of phenolic compound to change the nano silver ion into different shapes, make it more tightly combined with phenolic composite fiber cloth, not easy to fall off from it and enhance the antibacterial performance, and it can be washed with water to a method for preparing the nano silver active filter element, comprising the following steps of: achieve the effect of long-term antibacterial and antibacterial performance.

Preparation Method 1

S1: preparation of phenolic composite fiber;

S11: a polyester non-woven cloth is dried at 120° C. for 4.5 h, then pick it out and steam it in boiling water;

S12: add 180 g trihydromethyl aminomethane into 800 ml of deionized water in 1 L beaker, fully stir to dissolve the trihydromethylaminomethane, cool to room temperature, add 20 ml thick HCl into the beaker, dilute the solution to 1 L, after high temperature and high pressure sterilization. Store it at room temperature, obtain trihydroxymethylaminomethane-hydrochloride buffer with PH 8.4;

S13:dissolve 4 g of phenolic compound in the trihydroxymethyl aminomethane-hydrochloride buffer obtained in step S12 to obtain a phenolic compound solution with a concentration of 4 g/L;

S14: the polyester fiber non-woven cloth obtained in step S11 is immersed in the phenolic compound solution obtained in step S13 at a bath ratio of 1:50, and the reaction is stirred for 10 min at room temperature at a stirring speed of 200 r/min;

S15: Take out the polyester fiber non-woven cloth treated in step S14, wash it with deionized water and absolute ethanol for 2˜5 times in turn, and air dry to obtain the phenolic composite fiber cloth with phenolic compound.

S2: preparation of a suspension containing nano silver ion, the specific preparation process is as follows:

S21: the nano silver wire, silicone and ethylene glycol are mixed at 100° C.˜120° C. according to the mass fraction ratio 0.01:1:1, and stirred for 4 h at a stirring speed of 150 r/min; the fully reacted solution is washed and dried to obtain modified silver nano wires;

S22: the modified nano silver wire obtained in step S21 is added to the mixed liquid that mass ratio is 1:3:2 a mixture of water, ethylene glycol and isopropanol to obtain a suspension containing nano silver ions with a mass ratio of 0.1%.

S3: preparation of the nano silver antimicrobial layer by loading the nano silver ion in the suspension obtained in step S2 into the surface microporous structure of the phenolic composite fiber obtained in step S1, the specific preparation process is as follows:

S31: the phenolic composite fiber cloth obtained in step S15 and the suspension containing nano silver ions obtained in step S22 are performed loading reaction by stirring and ultrasonically vibrating at a mass fraction ratio of 1:50 under the conditions of reaction temperature of 60° C. and reaction time of 30 min;

S32: after the loading reaction in step S31, the nano silver antibacterial layer is obtained by drying at a drying temperature of 30° C. and a drying time of 8 h;

S4: The nano silver antimicrobial layer, the filter layer, and the protective layer were stacked sequentially, which is processed into a coiled material by ultrasonic processing, the coiled material is cut into required specification through the strip machine; then the coiled material with the required specification is folded into W-shaped structure by a non-woven folding machine;

S5: according to the specific shape structure of the filter element, select the shaping mold and cutting mold that meet the requirements to cut the W-shaped structure obtained in step S3 to obtain the block sheet filter paper with required size; the fixed and/or bottom surfaces of the block sheet filter paper is glued to obtain a block sheet filter paper with predetermined fold angle parameters and finalized; the frame is adhesive to the periphery of the block sheet filter paper by hot melt to obtain the filter element body.

The two filter element bodies obtained by the preparation method of this embodiment are placed in a closed space of 0.5 m3, a predetermined amount of E. coli is released into the closed space, and the colony numbers A1 and A2 of the filter element body are tested after standing for 12 h. Wherein, the filter element body with colony number A1, and then the filter element body gives continuous vibration movement, and the circulating air with large air volume is introduced into the confined space for 12 h, stop vibration and ventilation, and then test the colony number B1 of the filter element body through the calculation method: (A1−B1)/A1×100%. According to the calculation method, the bacteriostatic rate of the filter element body after being subjected to external large air volume and high-frequency vibration is 99.7%. After washing the filter element body with colony number A2 for 3˜5 times, test the colony number B2 of the filter element body through the calculation method: (A2−B2)/A2×100% According to the calculation method, the antibacterial rate of the filter element body after several times of water washing is 99.5%.

Preparation Method 2

A method for preparing the nano silver active filter element, comprising the following steps of:

S1: preparation of phenolic composite fiber;

S11: a polyester nonwoven cloth is dried at 180° C. for 1.5 h, then pick it out and steam it in boiling water;

S12: add 120 g trihydromethyl aminomethane into 800 ml of deionized water in 1 L beaker, fully stir to dissolve the trihydromethyl aminomethane, cool to room temperature, add 70 ml thick HCl into the beaker, dilute the solution to 1 L, after high temperature and high pressure sterilization. Store it at room temperature, obtain trihydroxymethyl aminomethane-hydrochloride buffer with pH 7.4;

S13: dissolve 15 g of phenolic compound in the trihydroxymethyl aminomethane hydrochloric acid buffer obtained in step S12 to obtain a phenolic compound solution with a concentration of 0.5 g/L;

S14: the polyester fiber non-woven cloth obtained in step S11 is immersed in the phenolic compound solution obtained in step S13 at a bath ratio of 1:50, and the reaction is stirred for 30 min at room temperature at a stirring speed of 100 r/min;

S15: Take out the polyester fiber non-woven cloth treated in step S14, wash it with deionized water and absolute ethanol for 2˜5 times in turn, and air dry to obtain the phenolic composite fiber cloth with phenolic compound.

S2: preparation of a suspension containing nano silver ion, the specific preparation process is as follows:

S21: the nano silver wire, silicone and ethylene glycol are mixed at 100° C.˜120° C. according to the mass fraction ratio 0.04:4:1, and stirred for 2 h at a stirring speed of 300 r/min; the fully reacted solution is washed and dried to obtain modified silver nano wires;

S22: the modified nano silver wire obtained in step S21 is added to the mixed liquid that mass ratio is 1:5:4 a mixture of water, ethylene glycol and isopropanol to obtain a suspension containing nano silver ions with a mass ratio of 0.01%.

S3: preparation of the nano silver antimicrobial layer by loading the nano silver ion in the suspension obtained in step S2 into the surface microporous structure of the phenolic composite fiber obtained in step S1, the specific preparation process is as follows:

S31: the phenolic composite fiber cloth obtained in step S15 and the suspension containing nano silver ions obtained in step S22 are performed loading reaction by stirring and ultrasonically vibrating at a mass fraction ratio of 1:150 under the conditions of reaction temperature of 90° C. and reaction time of 30 min;

S32: after the loading reaction in step S31, the nano silver antibacterial layer is obtained by drying at a drying temperature of 30° C. and a drying time of 4 h;

S4: The nano silver antimicrobial layer, the filter layer, and the protective layer were stacked sequentially, which is processed into a coiled material by ultrasonic processing, the coiled material is cut into required specification through the strip machine; then the coiled material with the required specification is folded into W-shaped structure by a non-woven folding machine;

S5: according to the specific shape structure of the filter element, select the shaping mold and cutting mold that meet the requirements to cut the W-shaped structure obtained in step S3 to obtain the block sheet filter paper with required size; the fixed and/or bottom surfaces of the block sheet filter paper is glued to obtain a block sheet filter paper with predetermined fold angle parameters and finalized; the frame is adhesive to the periphery of the block sheet filter paper by hot melt to obtain the filter element body.

The two filter element bodies obtained by the preparation method of this embodiment are placed in a closed space of 0.5 m3, a predetermined amount of E. coli is released into the closed space, and the colony numbers A1 and A2 of the filter element body are tested after standing for 12 h. Wherein, the filter element body with colony number A1, and then the filter element body gives continuous vibration movement, and the circulating air with large air volume is introduced into the confined space for 12 h, stop vibration and ventilation, and then test the colony number B1 of the filter element body through the calculation method: (A1−B1)/A1×100%. According to the calculation method, the bacteriostatic rate of the filter element body after being subjected to external large air volume and high-frequency vibration is 99.86%. After washing the filter element body with colony number A2 for 3˜5 times, test the colony number B2 of the filter element body through the calculation method: (A2−B2)/A2×100% According to the 100% calculation method, the antibacterial rate of the filter element body after several times of water washing is 99.7%.

Preparation Method 3

A method for preparing the nanosilver active filter element, comprising the following steps of:

S1: preparation of phenolic composite fiber;

S11: a polyester non-woven cloth is dried at 150° C. for 3 h, then pick it out and steam it in boiling water;

S12: add 150 g trihydromethylaminomethane into 800 ml of deionized water in 1 L beaker, fully stir to dissolve the trihydromethylaminomethane, cool to room temperature, add 50 ml thick HCl into the beaker, dilute the solution to 1 L, after high temperature and high pressure sterilization. Store it at room temperature, obtain trihydroxymethylaminomethane-hydrochloride buffer with PH 7.4;

S13: dissolve 4 g of phenolic compound in the trihydroxymethyl aminomethane hydrochloric acid buffer obtained in step S12 to obtain a phenolic compound solution with a concentration of 4 g/L;

S14: the polyester fiber non-woven cloth obtained in step S11 is immersed in the phenolic compound solution obtained in step S13 at a bath ratio of 1:50, and the reaction is stirred for 30 min at room temperature at a stirring speed of 100 r/min;

S15: Take out the polyester fiber non-woven cloth treated in step S14, wash it with deionized water and absolute ethanol for 2—5 times in turn, and air dry to obtain the phenolic composite fiber cloth with phenolic compound.

S2: preparation of a suspension containing nano silver ion, the specific preparation process is as follows:

S21: the nano silver wire, silicone and ethylene glycol are mixed at 120° C. according to the mass fraction ratio 0.02:4:1, and stirred for 2 h at a stirring speed of 250 r/min; the fully reacted solution is washed and dried to obtain modified nano silver wires;

S22: the modified nano silver wire obtained in step S21 is added to the mixed liquid that mass ratio is 1:4:3 a mixture of water, ethylene glycol and isopropanol to obtain a suspension containing nano silver ions with a mass ratio of 0.04%.

S3: preparation of the nano silver antimicrobial layer by loading the nano silver ion in the suspension obtained in step S2 into the surface microporous structure of the phenolic composite fiber obtained in step S1, the specific preparation process is as follows:

S31: the phenolic composite fiber cloth obtained in step S15 and the suspension containing nano silver ions obtained in step S22 are performed loading reaction by stirring and ultrasonically vibrating at a mass fraction ratio of 1:100 under the conditions of reaction temperature of 80° C. and reaction time of 30 min;

S32: after the loading reaction in step S31, the nano silver antibacterial layer is obtained by drying at a drying temperature of 30° C. and a drying time of 5 h;

S4: The nano silver antimicrobial layer, the filter layer, and the protective layer were stacked sequentially, which is processed into a coiled material by ultrasonic processing, the coiled material is cut into required specification through the strip machine; then the coiled material with the required specification is folded into W-shaped structure by a non-woven folding machine;

S5: according to the specific shape structure of the filter element, select the shaping mold and cutting mold that meet the requirements to cut the W-shaped structure obtained in step S3 to obtain the block sheet filter paper with required size; the fixed and/or bottom surfaces of the block sheet filter paper is glued to obtain a block sheet filter paper with predetermined fold angle parameters and finalized; the frame is adhesive to the periphery of the block sheet filter paper by hot melt to obtain the filter element body.

The two filter element bodies obtained by the preparation method of this embodiment are placed in a closed space of 0.5 m³, a predetermined amount of E. coli is released into the closed space, and the colony numbers A1 and A2 of the filter element body are tested after standing for 12 h. Wherein, the filter element body with colony number A1, and then the filter element body gives continuous vibration movement, and the circulating air with large air volume is introduced into the confined space for 12 h, stop vibration and ventilation, and then test the colony number B1 of the filter element body through the calculation method: (A1−B1)/A1×100%. According to the calculation method, the bacteriostatic rate of the filter element body after being subjected to external large air volume and high-frequency vibration is 99.7%. After washing the filter element body with colony number A2 for 3˜5 times, test the colony number B2 of the filter element body through the calculation method: (A2−B2)/A2×100% According to the calculation method, the antibacterial rate of the filter element body after several times of water washing is 99.6%.

While the specification has described in detail certain exemplary embodiments, it will be appreciated that those skilled in the art, upon attaining an understanding of the foregoing, may readily conceive of alterations to, variations of, and equivalents to these embodiments.

1. A nano silver active filter element, wherein comprising a filter element body, said filter element body comprising sheet filter papers stacked of layered composite structures, said sheet filter papers successively comprises a nano silver antibacterial layer, a filter layer and a protection layer from an air inlet surface of said filter element body to an air outlet surface of said filter element body; said nano silver antimicrobial layer is prepared from phenolic complex fibers loaded with nano silver particles.

2. The nano silver active filter element according to claim 1, wherein said sheet filter papers is arranged in a W shape.

3. The nano silver active filter element according to claim 2, wherein layers of said sheet filter papers are integrated in a whole by ultrasonic thermal pressure.

4. The nano silver active filter element according to claim 2, wherein a fixed surface and/or a bottom surface of said sheet filter papers are glued to form a glue line in said W shape.

5. The nano silver active filter element according to claim 1, wherein also comprising a frame, which is arranged at a side surface of said sheet filter papers; said sheet filter papers are seamlessly bonded to said frame in a hot melt manner.

6. The nano silver active filter element according to claim 5, wherein a side of said frame departing from said sheet filter papers is provided with a sealing member.

7. A method for preparing said nano silver active filter element according to claim 1, wherein includes following steps:
S1: preparation of a phenolic composite fiber;
S2: preparation of a suspension containing nano silver ion;
S3: preparation of said nano silver antimicrobial layer by loading said nano silver ion in said suspension obtained in step S2 into a surface microporous structure of said phenolic composite fiber obtained in step S1;
S4: said nano silver antimicrobial layer, said filter layer, and said protective layer are stacked sequentially, which is processed into a coiled material by ultrasonic processing, said coiled material is cut into required specification by a strip machine; said coiled material with required specification is folded into a W shaped structure by a non-woven folding machine;
S5: select a shaping mold and a cutting mold to cut said W-shaped structure obtained in step S3 to a block sheet filter paper; a fixed surface and/or a bottom surface of said block sheet filter paper is glued to obtain a block sheet filter paper with predetermined fold angle parameters and finalized; said frame is adhesive to said periphery of said block sheet filter paper by hot melt to obtain said filter element body.

8. The method for preparing said nano silver active filter element according to claim 7, wherein in step S1, specific preparation procedure is as follows:
S11: a polyester non-woven cloth is dried at 100° C.˜200° C. for 1 h˜5 h, pick it out and steam it in boiling water;
S12: add 120 g˜180 g trihydromethylaminomethane into 800 ml of deionized water in 1 L beaker, fully stir to dissolve said trihydromethylaminomethane, cool to room temperature, add 20 ml˜70 ml thick HCl into said beaker, dilute to 1 L, after high temperature and high pressure sterilization, store it at room temperature, obtain trihydroxymethylaminomethane-hydrochloride buffer with pH 7.4˜8.8;
S13: dissolve 4 g˜15 g of phenolic compound in said trihydroxymethyl aminomethane-hydrochloride buffer obtained in step S12 to obtain a phenolic compound solution with a concentration of 0.5 g/L˜4 g/L;
S14: said polyester fiber non-woven cloth obtained in step S11 is immersed in said phenolic compound solution obtained in step S13 at a bath ratio of 1:50, and stirred for 10 min˜30 min at room temperature at a stirring speed of 100 r/min˜200 r/min;
S15: Take out said polyester fiber non-woven cloth obtained in step S14, wash it with said deionized water and absolute ethanol for 2˜5 times in turn, and air dry to obtain said phenolic composite fiber cloth with phenolic compound.

9. The method for preparing said nano silver active filter element according to claim 8, wherein in step S2, specific preparation process is as follows:
S21: nano silver wire, silicone and ethylene glycol are mixed at 100° C.˜120° C. according to a mass fraction ratio (0.01˜0.04): (1˜4):1, and stir for 2 h˜4 h at a stirring speed of 150 r/min˜300 r/min; said reacted solution is washed and dried to obtain modified nano silver wire;
S22: said modified nano silver wire obtained in step S21 is added to a mixed liquid that mass ratio is 1:(3˜5): (2˜4) a mixture of water, ethylene glycol and isopropanol to obtain a suspension containing nano silver ion with a mass ratio of 0.01%˜0.1%.

10. The method for preparing said nano silver active filter element according to claim 9, wherein in step S3, specific preparation process is as follows:
S31: said phenolic composite fiber cloth with phenolic compound obtained in step S15 and said suspension containing nano silver ion obtained in step S22 are performed loading reaction by stirring and ultrasonically vibrating at a mass ratio of 1:50˜1:150 under said conditions of reaction temperature of 60° C.˜90° C. and reaction time of 30 min˜50 min;
S32: after said loading reaction in step S31, said nano silver antibacterial layer is obtained by drying at a drying temperature of 30° C.˜50° C. and a drying time of 3 h˜8 h.
